(19) United States
(12) Patent Application Publication
(10) Pub. No.: US 2010/0043937 A1
(43) Pub. Date: Feb. 25, 2010

(54) LOW-NOISE PNEUMATIC TIRE

(75) Inventors: Futoshi Matsunaga, Hiratsuka-shi (JP); Jun Matsuda, Hiratsuka-shi (JP)

Correspondence Address: Connolly Bove Lodge & Hutz LLP, Suite 1100, 1875 Eye Street, NW, Washington, DC, 20006, US

(73) Assignee: The Yokohama Rubber Co., Ltd., Tokyo (JP)

(21) Appl. No.: 12/543,569

(22) Filed: Aug. 19, 2009

(30) Foreign Application Priority Data
Aug. 20, 2008 (JP) JP2008-211545

(51) Int. Cl. B60C 9/02

(52) U.S. Cl. 152/564

(57) ABSTRACT

Provided is a low-noise pneumatic tire for reducing a cavity resonance sound generated inside the tire. An inner liner layer is made of a thermoplastic resin or a thermoplastic elastomer composition formed by blending the thermoplastic resin with an elastomer. Multiple types of convex portions differing from each other in protruding height h are formed on at least a region of an inner wall surface of the inner liner layer, the region corresponding to a tread portion. Each of the convex portions has a strip shape, protrudes from the inner liner layer, and extends in a tire width direction. The convex portions are intermittently arranged in a tire circumferential direction.

### BACKGROUND OF THE INVENTION

1. Field of the Invention

The present invention relates to a low-noise pneumatic tire, and more specifically to a low-noise pneumatic tire for reducing a cavity resonance sound generated inside the tire.

2. Description of the Related Art

One of the causes of tire noise is a cavity resonance sound that occurs due to vibration of air filled inside the tire. When the tire rolls under load, a tread portion that comes into contact with a road surface is vibrated by the roughness of the road surface, and this vibration causes the air inside the tire to resonate. Accordingly, the cavity resonance sound is generated. The sound that is heard as a noise in this cavity resonance sound is known to have a frequency around approximately 230 Hz.

Conventionally, as a proposed technique for reducing a noise due to such a cavity resonance phenomenon, a rubber-made partition plate extending in a width direction is provided to a tire inner portion (see, for example, Japanese patent: application Kokai publication No. Hei. 5-294102). Thereby, the resonance mode in the tire cavity portion is changed to reduce the sound pressure level. However, when such a rubber-made partition plate is provided to the inner portion of a cured tire, the partition plate is repeatedly deformed by rolling of the tire and detached from the tire inner portion after an extended period of use. For this reason, this technique has a durability problem and also has a problem that the noise-reducing effect is difficult to maintain over an extended period.

As this countermeasure, the present applicant has made a proposal as follows. Specifically, thin films are intermittently arranged on an inner wall surface of an inner liner layer in a tire circumferential direction. The thin films are made of the same material as that of an inner liner layer. The thin films erect from the inner liner layer and extend in a tire width direction. The thin films thus arranged change the resonance mode in the tire cavity to reduce the sound pressure level (see Japanese patent application Kokai publication No. 2007-62541). Nevertheless, in the later researches, the present applicant has found out that the noise characteristic is improved by forming multiple types of thin films differing from each other in height, the thin films being arranged in an appropriate combination in a tire circumferential direction and erecting from an inner liner layer. Thus, the present invention has been achieved.

### SUMMARY OF THE INVENTION

The present invention is to improve the invention described in Japanese patent application Kokai publication No. 2007-62541. An object of the present invention is to provide a low-noise pneumatic tire capable of further reducing a cavity resonance sound generated inside the tire.

The low-noise pneumatic tire of the present invention to accomplish the above object is characterized as follows. Specifically, the pneumatic tire includes an inner liner layer made of a thermoplastic resin or a thermoplastic elastomer composition formed by blending the thermoplastic resin with an elastomer. Multiple types of convex portions differing from each other in protruding height are formed on at least a region of an inner wall surface of the inner liner layer, the region corresponding to a tread portion. Each of the convex portions has a strip shape, protrudes from the inner liner layer, and extends in a tire width direction. The convex portions are intermittently arranged in a tire circumferential direction.

Furthermore, in the above-described structure, the low-noise pneumatic tire of the present invention is preferably structured as described in (1) to (5) below.

(1) The convex portions are formed of at least three types, each type differing from the others in protruding height.

(2) The convex portions differing from each other in protruding height are arranged in the tire circumferential direction in random order.

(3) Each of the convex portions has a protruding height of 1.5 mm to 20 mm.

(4) The convex portions are made of a thermoplastic resin or a thermoplastic elastomer composition formed by blending the thermoplastic resin with an elastomer.

(5) Each of the convex portions is formed into such a shape that the convex portion has a vertex in a central region of the convex portion in the tire width direction.

In the low-noise pneumatic tire of the present invention, the multiple types of convex portions differing from each other in protruding height are formed on at least the region of the inner wall surface of the inner liner layer, the region corresponding to the tread portion. Each of the convex portions has a strip shape, protrudes from the inner liner layer, and extends in the tire width direction. The convex portions are intermittently arranged in the tire circumferential direction. Accordingly, the multiple types of convex portions differing from each other in protruding height efficiently diffuse resonance sounds generated in a tire cavity portion, and the resonance sounds cancel each other out because of the diffuse reflection. Thus, a noise in the vehicle compartment is further reduced.

### BRIEF DESCRIPTION OF THE DRAWINGS

FIG. 1 is a meridian cross-sectional view showing an example of a low-noise pneumatic tire according to an embodiment of the present invention.

FIGS. 2A and 2B are side views each showing a cross section of a principal portion taken along the center line of the tire in FIG. 1, schematically illustrating an arrangement of convex portions of the tire.

FIG. 3 is a partial side view showing an enlarged cross section A-A in FIG. 1.

FIGS. 4A to 4D are partial plan views each showing an inner liner layer of the tire in FIG. 1, as seen from the tire center side toward the tire outer circumferential side, illustrating an arrangement of the convex portions.

FIG. 5 is an explanatory drawing for illustrating steps in manufacturing the low-noise pneumatic tire of the present invention.

FIG. 6 is an explanatory drawing for illustrating a step of forming a convex portion in the obtained low-noise pneumatic tire in FIG. 5.

FIG. 7 is an explanatory drawing for illustrating a step in manufacturing a low-noise pneumatic tire according to another embodiment of the present invention, corresponding to FIG. 5.

### DESCRIPTION OF THE PREFERRED EMBODIMENTS

Hereinafter, a structure of the present invention will be described in detail with reference to the accompanying drawings.

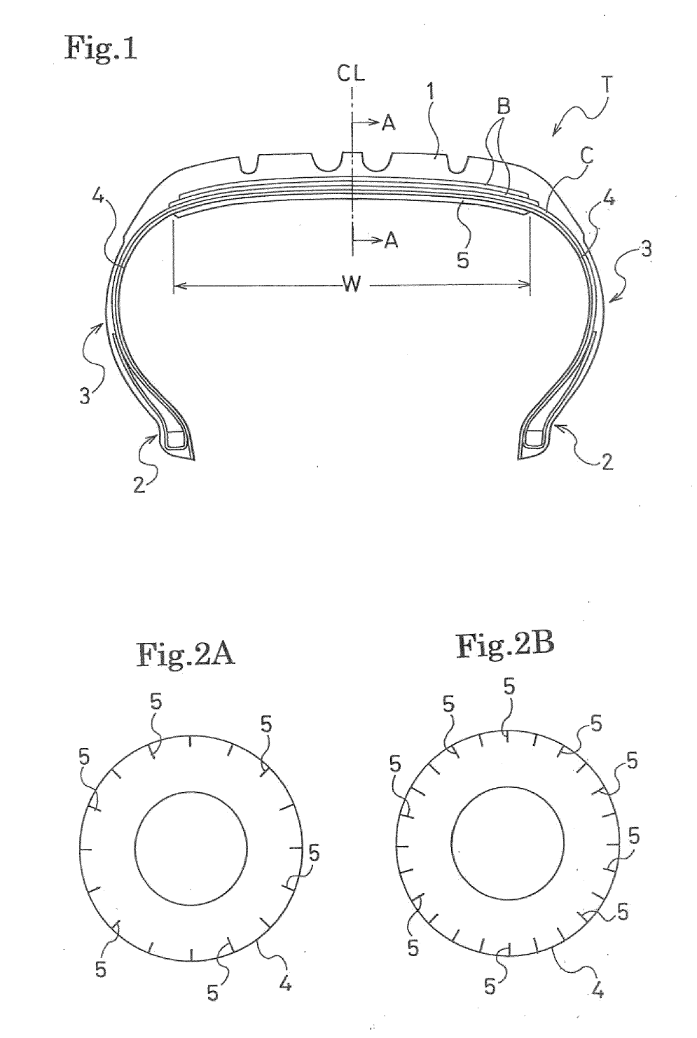

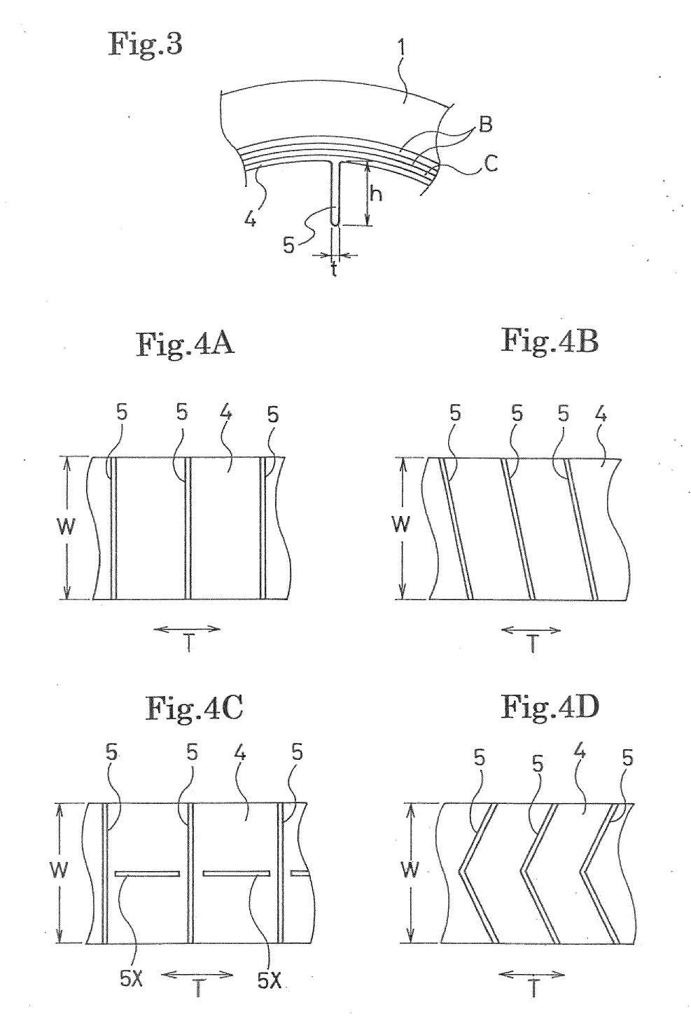

FIG. 1 is a meridian cross-sectional view showing an example of a low-noise pneumatic tire of the present invention. FIGS. 2A and 2B are side views each showing a cross section of a chief part taken along a tire center line CL, schematically illustrating an arrangement of convex portions formed on an inner wall surface of an inner liner layer In the tire of FIG. 1. FIG. 3 is a partial side view showing an enlarged cross section A-A in FIG. 1.

In FIG. 1, a low-noise pneumatic tire T includes a tread portion 1, a right and left pair of bead portions 2, 2, and side wall portions 3, 3 that connect the tread portion 1 to the bead portions 2, 2. An inner liner layer 4 is disposed on the Inner surface of the low-noise pneumatic tire T so as to maintain the tire inflation pressure constant. The inner liner layer 4 is made of a thermoplastic resin or a thermoplastic elastomer composition formed by blending the thermoplastic resin with an elastomer. In the drawings, reference symbol B denotes a belt layer, and reference symbol C denotes a carcass layer.

Moreover, multiple types or convex portions 5 each having a strip shape and extending in a tire width direction are formed on at least a region of the inner wall surface of the inner liner layer 4, the region corresponding to the tread portion1 (in the drawing, the region is indicated by W extending across the inner wall surface of the tread portion 1). The convex portions 5 protrude from the inner liner layer 4, and differ from each other in protruding height h (see FIG. 3). These convex portions 5 are intermittently arranged in a tire circumferential direction as exemplified in FIGS. 2A and 2B.

Incidentally, FIG. 2A shows that 16 convex portions 5 differing in protruding height are arranged, in random order, on the inner wall surface of the inner liner layer 4 at equal intervals in the tire circumferential direction. FIG. 2B shows that 20 convex portions 5 differing in protruding height are arranged, in random order, on the inner wall surface of the inner liner layer 4 at equal intervals in the tire circumferential direction.

In the above-described embodiment of FIG. 1, exemplified is the case where the convex portions 5 are formed in the tire width direction across the region W of the inner wall surface of the tread portion 1. However, the convex portions 5 may be formed in such a manner that both ends thereof extend from the center of the inner wall surface of the tread portion 1 to regions of inner wall surfaces of both the side wall portions 3, 3. Alternatively, both ends of the convex portions 5 may be formed all over the region of the inner wall surface of the inner liner layer 4.

Furthermore, in the embodiment of FIG. 1, exemplified is the case where the convex portions 5 are arranged at equal intervals in the tire circumferential direction. However, the convex portions 5 may be arranged at somewhat different intervals from one place to the adjacent places in the tire circumferential direction. Meanwhile, regarding the protruding height h of the convex portion 5, any of the convex portions 5 may be formed to have a uniform protruding height h in the tire width direction, or have various protruding heights h. In the latter case, the maximum and minimum values of the protruding heights h are averaged, and this average value is used as the protruding height h of the convex portion 5.

In this manner, the multiple types of the convex portions 5 differing from each other in protruding height h are formed on the inner wall surface of the inner liner layer 4. Thereby, the convex portions 5 differing in protruding height h efficiently diffuses resonance sounds generated in a tire cavity portion, and these resonance sounds cancels each other out by the diffused reflection. Thereby, the noise in the vehicle compartment is further reduced.

In the present invention, depending on the size and type of tire, 15 to 30 of the convex portions 5 should be formed on the inner wall surface of the inner liner layer 4 on the tire circumference. If the number of the convex portions 5 formed on the tire circumference is too small, or too large in the other case, the effect of reducing a noise in the vehicle compartment is decreased.

In the low-noise pneumatic tire T of the present invention, the inner liner layer 4 is made of a thermoplastic resin or a thermoplastic elastomer composition formed by blending the thermoplastic resin with an elastomer. Examples of the thermoplastic resin to be used include polyamide resins, their N-alkoxyalkylated products, polyester resins, polynitrile resins, cellulose resins, and imide resins.

The thermoplastic elastomer composition is formed by blending the above-described thermoplastic resin with an elastomer. Examples of the elastomer to be used for forming the thermoplastic elastomer composition include diene rubbers and their hydrogenated products, olefin rubbers, halogen-containing rubbers, silicone rubbers, and fluororubbers.

The thermoplastic elastomer composition thus obtained has a structure in which the elastomer component is dispersed as the discontinuous phase in the matrix of the thermoplastic resin. With such a structure, it becomes possible to provide the thermoplastic elastomer composition with both sufficient flexibility and sufficient stiffness that is attributed to the effect of the resin layer as the continuous phase. It also becomes possible to obtain, in molding, a molding processability equivalent to the case of a thermoplastic resin regardless of the amount of elastomer components.

In the low-noise pneumatic tire T of the present invention, the above-described convex portions 5 are formed of preferably at least three types, or more preferably at most six types, each type differing from each other in protruding height. This enables efficient diffused reflection of cavity resonance sounds generated inside the tire. Thus, the cavity resonance sounds cancel each other out, and the noise-reducing effect is surely improved.

Further preferably, such at least three types of the convex portions 5 are arranged in the tire circumferential direction in random order. This allows further efficient diffused reflection of cavity resonance sounds generated inside the tire, and further improves the noise-reduction effect attributed to the cancelling of the cavity resonance sounds by themselves.

Additionally, the above-described protruding height h of the convex portion 5 should be adjusted to 1.5 mm to 20 mm, and preferably 2 mm to 5 mm. If the minimum value of the protruding height h is less than 1.5 mm, the noise-reduction effect is not satisfactory. Meanwhile, if the maximum value of the protruding height h exceeds 20 mm, the weight balance of the tire may be disturbed.

FIG. 3 is the partial side view showing the enlarged cross section A-A in FIG. 1. This embodiment illustrates a case where the convex portion 5 is formed integrally with the inner liner layer 4. In the low-noise pneumatic tire T of the present invention, a thickness t of the convex portion 5 shown in FIG. 3 is not particularly limited. However, the thickness t is set preferably from 50 μm to 1500 μm, and most preferably from 100 μm to 500 μm. If the thickness t of the convex portion 5 is smaller than 50 μm, the convex portion 5 may fall toward the inner liner layer 4 due to a centrifugal force during high-speed running of the tire; as a result, the effect of reducing a cavity resonance sound may not be obtained sufficiently. Meanwhile, if the thickness t exceeds 1500 μm, the weight balance of the tire may be disturbed.

The storage elasticity of the convex portion 5 at 20° C. should be set preferably 10 MPa to 500 MPa, and further preferably 25 MPa to 400 MPa. Thereby, even when the tire is used for high-speed running, the convex portion 5 is prevented from falling toward the tire inner surface, and cavity resonance sounds generated inside the tire efficiently cancel each other out. If the above-described storage elasticity is less than 10 MPa, the noise-reducing effect is not satisfactory in some cases. Meanwhile, if the storage elasticity exceeds 500 MPa, the convex portion 5 is stiffened excessively, and the vibration is likely to happen in some cases. Note that the above-described storage elasticity indicates a value determined using a viscoelastic spectrometer, manufactured by Toyo Seiki Seisaku-sho, Ltd., under condition of static strain of 10%, dynamic strain of ±2%, and frequency of 20 Hz.

In the low-noise pneumatic tire T of the present invention, the material of the above-described convex portion 5 is not particularly limited. However, the material is preferably, as similar to the inner liner layer 4, a thermoplastic resin or a thermoplastic elastomer composition formed by blending the thermoplastic resin with an elastomer. Further preferably, the convex portion 5 is made of the same material as that of the inner liner layer 4. Thereby, the integrity with the inner liner layer 4 is ensured. This prevents the convex portion 5 from being detached from the inner liner layer 4 due to the repetitive deformation by rolling of the tire, and maintains the noise-reducing effect over an extended period.

Examples of the thermoplastic resin that can be preferably used for forming the convex portion 5 include: polyamide resins (for example, nylon 6 (N6), nylon 66 (N66), nylon 46 (N46), nylon 11 (N11), nylon 12 (N12), nylon 610 (N610), nylon 612 (N612), nylon 6/66 copolymers (N6/66), nylon 6/66/610 copolymers (N6/66/610), nylon MXD6 (MXD6), nylon 6T, nylon 6/6T copolymers, nylon 66/PP copolymers, and nylon 66/PPS copolymers); their N-alkoxyalkylated products (for example, methoxymethylated nylon 6, methoxymethylated nylon 6/610 copolymers, and methoxymethylated nylon 612); polyester resins (for example, aromatic polyesters, such as polybutylene terephthalate (PBT), polyethylene terephthalate (PET), polyethylene isophthalate (PEI), PET/PEI copolymers, polyarylate (PAR), polybutylene naphthalate (PBN), liquid crystal polyester, and polyoxyalkylene diimide diacid/polybutylene terephthalate copolymers); polynitrile resins (for example, polyacrylonitrile (PAN), polymethacrylonitrile, acrylonitrile/styrene copolymers (AS), (meth)acrylonitrile/styrene copolymers, and (meth)acrylonitrile/styrene/butadiene copolymers); polymethacrylate resins (for example, poly(methyl methacrylate) (PMMA), poly(ethyl methacrylate)); polyvinyl resins (for example, polyvinyl acetate, polyvinyl alcohol (PVA), vinyl alcohol/ethylene copolymers (EVOH), polyvinylidene chloride (PVDC), polyvinyl chloride (PVC), vinyl chloride/vinylidene chloride copolymers, vinylidene chloride/methyl acrylate copolymers, vinylidene chloride/acrylonitrile copolymers); cellulose resins (for example, cellulose acetate and cellulose acetate butyrate); fluororesins (for example, polyvinylidene fluoride (PVDF), polyvinyl fluoride (PVF), polychlorotrifluoroethylene (PCTFE), and ethylene/tetrafluoroethylene (ETFE) copolymers) ; and imide resins (for example, aromatic polyimide (PI)).

The thermoplastic elastomer composition for forming the convex portion 5 can be formed by blending the above-described thermoplastic resin with an elastomer.

Examples of the elastomer that can be preferably used for forming the thermoplastic elastomer composition include: diene rubbers and their hydrogenated products (for example, natural rubbers (NR), isoprene rubber (IR), epoxidized natural rubbers, styrene-butadiene rubber (SBR), butadiene rubbers (BR, high-cis BR and low-cis BR), nitrile rubber (NBR), hydrogenated NBR, and hydrogenated SBR); olefin rubbers (for example, ethylene propylene rubbers (EPDM and EPM), maleic acid-modified ethylene propylene rubber (M-EPM), butyl rubber (IIR), copolymers of isobutylene and aromatic vinyl or diene monomer, acrylic rubber (ACM), and ionomers); halogen-containing rubbers (for example, Br-IIR, Cl-IIR, brominated isobutylene-p-methylstyrene copolymers (Br-IPMS), chloroprene rubber (CR), hydrin rubber (CHR), chlorosulfonated polyethylene rubber (CSM), chlorinated polyethylene rubber (CM), and maleic acid-modified chlorinated polyethylene rubber (M-CM)); silicone rubbers (for example, methyl vinyl silicone rubber, dimethyl silicone rubber, and methylphenyl vinyl silicone rubber); sulfur-containing rubbers (for example, polysulfide rubber); fluororubbers (for example, vinylidene fluoride rubbers, fluorine-containing vinyl ether rubbers, tetrafluoroethylene-propylene rubbers, fluorine-containing silicone rubbers, and fluorine-containing phosphazene rubbers); and thermoplastic elastomers (for example, styrene elastomers, olefin elastomers, ester elastomers, urethane elastomers, and polyamide elastomers).

If a particular thermoplastic resin among those described above is incompatible with such an elastomer, a compatibilizer may be used as a third component appropriately to make the two compatible with each other. By mixing such a compatibilizer into the blend system, the interfacial tension between the thermoplastic resin and the elastomer is reduced. As a result, the rubber particles constituting the dispersion phase are made finer, so that both components exhibit their characteristics more effectively. In general, such a compatibilizer has a copolymer structure of at least one of the thermoplastic resin and the elastomer, or a copolymer structure having an epoxy group, a carbonyl group, a halogen group, an amino group, an oxazoline group, a hydroxyl group, or the like, which is capable of reacting with the thermoplastic resin or the elastomer. The compatibilizer can be selected depending on the type of the thermoplastic resin and the elastomer to be mixed therewith. Examples of what is normally used include styrene/ethylene-butylene-styrene block copolymers (SEBS) and their maleic acid-modified products, EPDM, EPM, EPDM/styrene or EPDM/acrylonitrile graft copolymers and their maleic acid-modified products, and styrene/maleic acing copolymers, reactive phenoxine. The blending proportion of such a compatibilizer is not particularly limited, but is preferably 0.5 to 10 parts by weight relative to 100 parts by weight of the polymer components (the total amount of the thermoplastic resin and the elastomer).

In the thermoplastic elastomer composition, the component ratio of a particular thermoplastic resin to a particular elastomer is not particularly limited, and may be appropriately set so as to have a structure in which the elastomer is dispersed as a discontinuous phase in a matrix of the thermoplastic resin. However, the preferable range is 90/10 to 30/70 in weight ratio.

In the present invention, the thermoplastic resin and the thermoplastic elastomer composition each of which forms the convex portion 5 may be mixed with another polymer, for example, the above-described compatibilizer. The purposes of mixing such a polymer are to improve the compatibility between the thermoplastic resin and the elastomer, to improve the molding processability of the material, to improve the heat resistance, to reduce cost, and so on. Examples of the material used for the polymer include polyethylene (PE), polypropylene (PP), polystyrene (PS), ABS, SBS, and polycarbonate (PC). In addition, it is possible to optionally blend the convex portions 5 with a filler (calcium carbonate, titanium oxide, alumina, or the like) generally blended with a polymer blend, a reinforcement such carbon black and white carbon, a softener, a plasticizer, a processing aid, a pigment, a dye, an antidegradant, or the like, as long as such an agent does not harm the characteristic required as the convex portions 5.

The thermoplastic elastomer composition thus obtained has a structure in which the elastomer component is dispersed as the discontinuous phase in the matrix of the thermoplastic resin. With such a structure, it becomes possible to provide the thermoplastic elastomer composition with both sufficient flexibility and sufficient stiffness that is attributed to the effect of the resin layer as the continuous phase. It also becomes possible to obtain, in molding, a molding processability equivalent to the case of a thermoplastic resin regardless of the amount of elastomer components.

When mixed with the thermoplastic resin, the above-described elastomer can be dynamically cured. A curing agent, a curing assistant, curing conditions (temperature, time), and the like, during the dynamic curing can be determined as appropriate in accordance with the composition of the elastomer to be added, and are not particularly limited.

As the curing agent, a generally-available rubber curing agent (crosslinking agent) can be used. Specifically, examples of a sulfur-based curing agent include a sulfur powder, precipitated sulfur, highly dispersible sulfur, surface-treated sulfur, non-soluble sulfur, dimorpholin disulfide, and alkylphenol disulfide. Such a curing agent can be used in an amount of, for example, approximately 0.5 to 4 phr. Note that “phr” herein refers to parts by weight per 100 parts by weight of the elastomer component.

Moreover, examples of an organic peroxide-based curing agent include benzoyl peroxide, t-butyl hydroperoxide, 2,4-dichlorobenzoyl peroxide, 2,5-dimethyl-2,5-di(t-butyl peroxy)hexane, and 2,5-dimethylhexane-2,5-di(peroxyl benzoate). Such an organic peroxide-based curing agent can be used in an amount of, for example, approximately 1 to 20 phr.

Furthermore, examples of a phenol resin-based curing agent includes brominated alkylphenol resins and mixed crosslinking system containing an alkyl phenol resin with a halogen donor such as tin chloride and chloroprene. Such a phenol resin-based curing agent can be used in an amount of, for example, approximately 1 to 20 phr.

Examples of other curing agents include zinc white (approximately 5 phr), magnesium oxide (approximately 4 phr), litharge (approximately 10 to 20 phr), p-quinone dioxime, p-dibenzoylquinone dioxime, tetrachloro-p-benzoquinone, poly-p-dinitrosobenzene (approximately 2 to 10 phr), and methylenedianiline (approximately 0.2 to 10 phr).

As necessary, a curing accelerator may be added. Examples of the curing accelerator are aldehyde-ammonia-based, guanidine-based, thiazole-based, sulfenamide-based, thiuram-based, dithioic acid salt-based, and thiourea-based curing accelerators which are generally available. Such a curing accelerator can be used in an amount of, for example, approximately 0.5 to 2 phr.

Specifically, an example of the aldehyde-ammonia-based curing accelerator includes hexamethylenetetramine. An example of the guanidine-based curing accelerator includes diphenylguanidine. Examples of the thiazole-based curing accelerator include dibenzothiazyl. disulfide (DM), 2-mercapto benzothiazole and their Zn salts, and cyclohexylamine salts. Examples of the sulfenamide-based curing accelerator include cyclohexylbenzothiazyl sulfenamide (CBS), N-oxydiethylenebenzothiazyl-2-sulfenamide, N-t-butyl-2-benzothiazole sulfenamide, and 2-(thymolpolynyldithio)benzothiazole. Examples of the thiuram-based curing accelerator include tetramethylthiuram disulfide (TMTD), tetraethylthiuram disulfide, tetramethylthiuram monosulfide (TMTM), and dipentamethylenethiuram tetrasulfide. Examples of the dithioic acid salt-based curing accelerator include Zn-dimethyldithiocarbamate, Zn-diethyldithiocarbamate, Zn-di-n-butyldithiocarbamate, Zn-ethylphenyldithiocarbamate, Te-diethyldithiocarbamate, Cu-dimethyldithiocarbamate, Fe-dimethyldithiocarbamate, and pipecoline pipecolyldithiocarbamate. Examples of the thiourea-based curing accelerator include ethylene thiourea and diethylthiourea.

Additionally, a curing accelerator assistant generally-used for a rubber can be used. For example, zinc white (approximately 5 phr), stearic acid, oleic acid and their Zn salts (approximately 2 to 4 phr), or the like, can be used.

A method for producing the thermoplastic elastomer composition is as follows. The thermoplastic resin and the elastomer (uncured one in the case of rubber) are melt-kneaded in advance by a bi-axial kneader/extruder or the like. The elastomer is dispersed as a dispersion phase (domain) in the thermoplastic resin forming a continuous phase (matrix). When the elastomer is cured, a curing agent can be added during the kneading process to dynamically cure the elastomer. Although the various compounding agents (except for curing agent) may be added to the thermoplastic resin or the elastomer during the kneading process, it is preferable to premix the compounding agents before the kneading process. The kneader used for kneading the thermoplastic resin and the elastomer is not particularly limited. A screw extruder, kneader, Banbury Mixer, bi-axial kneader/extruder, or the like can be used as the kneader. Among these, a bi-axial kneader/extruder is preferably used for kneading the thermoplastic resin and the elastomer and for dynamically curing the elastomer. Furthermore, two or more types of kneaders can be used to successively knead the thermoplastic resin and the elastomer. As the condition for the melt kneading, the temperature should be at a temperature at which the thermoplastic resin melts or at a higher temperature. The shear rate at the time of kneading is preferably 1000 to 7500 sec⁻¹. The overall kneading time is 30 seconds to 10 minutes. When the curing agent is added, the curing time after the addition is preferably 15 seconds to 5 minutes. The polymer composition produced by the above method may be formed into a desired shape by a generally-used method for forming a thermoplastic resin such as injection molding and extrusion molding.

In the low-noise pneumatic tire T of the present invention, the convex portions 5 can be arranged as follows. Specifically, the convex portions 5 can be formed straight to extend in the tire width direction as shown in FIG. 4A. Alternatively, the convex portions 5 can be formed somewhat inclined to the tire width direction as shown in FIG. 4B. Furthermore, as exemplified in FIG. 4C, other convex portions 5x extending in a tire circumferential direction T can be formed in addition to the convex portions 5 shown in FIG. 4A to thereby enhance the noise-reducing effect. Incidentally, although FIG. 4C exemplifies that the convex portions 5 and the other convex portions 5x are arranged apart from each other at certain intervals, the convex portions 5 and the other convex portions 5x can be formed into a lattice pattern in which both the convex portions are connected to each other.

Furthermore, as exemplified in FIG. 4D, each of the convex portions 5 can be formed into such a shape that the convex portion 5 is bent so as to have a vertex 5a in a central region of the convex portion 5 in the tire width direction. In this manner, the convex portion 5 is prevented from falling toward the tire inner surface, even when the tire is used for high-speed running. Accordingly, cavity resonance sounds generated inside the tire efficiently cancel each other out. Note that the intervals between adjacent two of the convex portions 5, 5 in the tire circumferential direction T in FIGS. 4A to 4D may be set equally as described above or may be set differently in regular or irregular manner.

In addition, the material for forming the above-described other convex portions 5x in FIG. 4C is preferably, as similar to the convex portions 5, a thermoplastic resin or a thermoplastic elastomer composition formed by blending the thermoplastic resin with an elastomer. Furthermore, the protruding height of the convex portion 5x is preferably set from 1.5 mm to 20 mm as similar to the convex portion 5.

The low-noise pneumatic tire T of the present invention is manufactured by methods described below.

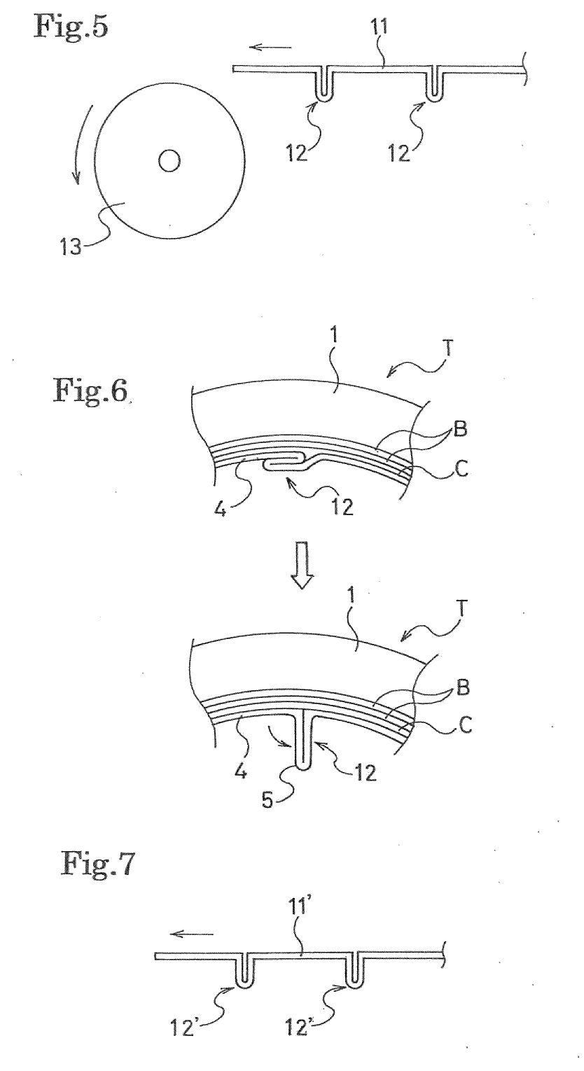

In a first manufacturing method, the material of an inner liner layer 4 is the same as that of convex portions 5. As shown in FIG. 5, folded portions 12 are intermittently formed at multiple spots in a longitudinal direction of a film 11 made of a thermoplastic resin or a thermoplastic elastomer composition formed by blending the thermoplastic resin with an elastomer. Each of the folded portions 12 has a U-shaped cross section in a width direction of the film 11. The folded portions 32 are different from each other in folded height. Then, the film 11 is wound, as an inner liner material, on a making drum 13 in such a manner that the folded portions 12 are folded on the inner side of the film 11. Subsequently, an uncured tire is formed, and this uncured tire is cure-molded. Thereafter, as shown in FIG. 6, the folded portion 12 is erected toward the center in a tire radial direction. Thus, a low-noise pneumatic tire T including the convex portions 5 on a tire inner wall surface is obtained.

In the low-noise pneumatic tire T thus obtained, the convex portions 5 and the inner liner layer 4 are made of the same material. Thus, it is possible to simply manufacture the low-noise pneumatic tire T, without a dedicated attaching step, including the convex portions 5 which are arranged on the tire inner wall surface, and which are not detached from the tire inner surface even after an extended period of use.

Moreover, in a second manufacturing method, the material of an inner liner layer 4 differs from that of convex portions 5. As shown in FIG. 7, folded portions 12′ are intermittently formed at multiple spots in a longitudinal direction of a film 11′ made of a thermoplastic resin or a thermoplastic elastomer composition formed by blending the thermoplastic resin with an elastomer. Each of the folded portions 12′ has a U-shaped cross section in a width direction of the film 11′. The folded portions 12′ are different from each other in folded height. Then, the film 11′ is wound on the making drum 13 shown in FIG. 5 in such a manner that the folded portions 12′ are folded on the inner side of the film 11′. Subsequently, an inner liner material is wound on the outer circumferential surface of the film 11′. Then, an uncured tire is formed, and this uncured tire is cure-molded. Thereafter, as described above in FIG. 6, the folded portion 12′ is caused to erect toward the center in a tire radial direction. Thus, a low-noise pneumatic tire T including the convex portions 5 on a tire inner wall surface is obtained.

Furthermore, in a third manufacturing method, a film which has convex portions 5, and which is made of a thermoplastic resin or a thermoplastic elastomer composition formed by blending the thermoplastic resin with an elastomer, is pasted on a cured tire inner wall surface. Thus, a low-noise pneumatic tire T including the convex portion 5 on the tire inner wall surface is obtained.

In the low-noise pneumatic tire T obtained according to the above-described first or second manufacturing method, the convex portions 5 have been formed on the tire inner wall surface in the stage of forming the uncured tire. Therefore, it is possible to simply manufacture the low-noise pneumatic tire T without a dedicated attaching step. Accordingly, the present invention is widely applicable as a technology to reduce a resonance sound in a cavity portion of the pneumatic tire.

### EXAMPLES

Tires of the present invention (Examples 1, 2), comparative tires (Comparative Examples 1, 2) and a conventional tire (Conventional Example) were prepared, each tire having a tire size of 215/55R17. In the conventional tire (Conventional Example), no convex portions were formed on a tire inner wall surface. In each tire of Examples and Comparative Examples, convex portions were formed at equal intervals on a tire circumference, at 24 spots of a region indicated by W extending across a tire inner wall surface as shown in FIG. 1. The tires of Examples and Comparative Examples differ from one another in specification of the convex portions (arrangements, the number of types of protruding heights, and protruding heights) as shown in Table 1.

Note that the tires of the present invention and the comparative tires included the convex portions each having a thickness t of 300 μm. In each tire of the present invention, among the 24 convex portions, groups each consisting of eight convex portions in the case of Example 1 and groups each consisting of six convex portions in the case of Example 2 had the same protruding heights, respectively. These convex portions were arranged in a tire circumferential direction in random order. Moreover, in Example 2 and Comparative Example 2, other convex portions extending in the tire circumferential direction were formed, and each of the other convex portions had a protruding height of 2.5 mm (uniform).

Each of these five types of tires was fitted onto a wheel having a rim size of 17×7 JJ, and the air pressure of the tire was set to 230 kPa. The tire assemblies of each type thus obtained were attached, as front and rear wheels, to a vehicle with an engine displacement of 3000 cc. A microphone was installed at a position on the window side of the driver seat in the vehicle compartment, so that the microphone was located close to an ear of a driver. The vehicle was run on a rough road surface at an average speed of 60 km/h to measure a noise (dB) in the vehicle compartment. The value in a frequency range around 230 Hz of the noise (dB) in the vehicle compartment was recorded in Table 1 with that of the conventional tire as reference.

TABLE 1

| | | Conventional | | | Comparative | Comparative |
|---|---|---|---|---|---|---|
| | | Example | Example 1 | Example 2 | Example 1 | Example 2 |
| Convex | Arrangement | — | FIG. 4A | FIG. 4C | FIG. 4A | FIG. 4C |
| portion | The number | — | 3 | 4 | 1 | 1 |
| | of types of | | | | | |
| | protruding | | | | | |
| | height | | | | | |
| | Protruding | — | 1.5, | 1.5, | 1.5 | 3.5 |
| | height (mm) | | 2.5, | 2.5, | | |
| | | | 3.5 | 3.5, | | |
| | | | | 4.5 | | |
| Result | Magnitude | Reference | −3.0 dB | −4.0 dB | −0.5 dB | −1.5 dB |
| | of noise in | | | | | |
| | vehicle | | | | | |
| | compartment | | | | | |

As apparent from Table 1, according to the tire of the present invention, the noise in a frequency range around 230 Hz in the vehicle compartment was reduced in comparison with the conventional tire and the comparative tires.

1. A low-noise pneumatic tire comprising:
an inner liner layer made of any one of a thermoplastic resin and a thermoplastic elastomer composition formed by blending the thermoplastic resin with an elastomer; and
convex portions intermittently arranged in a tire circumferential direction on an inner wall surface of the inner liner layer, each of the convex portions having a strip shape, protruding from the inner liner layer, and extending in a tire width direction, wherein
the convex portions are formed of a plurality of types, each type differing from the others in protruding height, and
the convex portions are arranged on at least a region of the inner wall surface of the inner liner layer, the region corresponding to a tread portion.

2. The low-noise pneumatic tire according to claim 1, wherein
the convex portions are formed of at least three types, each type differing from the others in protruding height.

3. The low-noise pneumatic tire according to claim 1, wherein
the convex portions differing from each other in protruding height are arranged in the tire circumferential direction in random order.

4. The low-noise pneumatic tire according to claim 1, wherein
each of the convex portions has a protruding height of 1.5 mm to 20 mm.

5. The low-noise pneumatic tire according to claim 1, wherein
the convex portions are made of any one of a thermoplastic resin and a thermoplastic elastomer composition formed by blending the thermoplastic resin with an elastomer.

6. The low-noise pneumatic tire according to claim 1, wherein each of the convex portions is formed into such a shape that the convex portion is bent to have a vertex in a central region of the convex portion in the tire width direction.

7. The low-noise pneumatic tire according to claim 2, wherein
the convex portions differing from each other in protruding height are arranged in the tire circumferential direction in random order.

8. The low-noise pneumatic tire according to claim 2, wherein
each of the convex portions has a protruding height of 1.5 mm to 20 mm.

9. The low-noise pneumatic tire according to claim 2, wherein
the convex portions are made of any one of a thermoplastic resin and a thermoplastic elastomer composition formed by blending the thermoplastic resin with an elastomer.

10. The low-noise pneumatic tire according to claim 2, wherein
each of the convex portions is formed into such a shape that the convex portion is bent to have a vertex in a central region of the convex portion in the tire width direction.
